(19) United States
(12) Patent Application Publication
(10) Pub. No.: US 2015/0026214 A1
(43) Pub. Date: Jan. 22, 2015

(54) System and Method for Facilitating Access to Open Public Records

(71) Applicant: New Jersey Appleseed Public Interest Law Center, Newark, NJ (US)

(72) Inventor: Sean Monahan, New Brunswick, NJ (US)

(73) Assignee: NEW JERSEY APPLESEED PUBLIC INTEREST LAW CENTER, Newark, NJ (US)

(21) Appl. No.: 14/335,131

(22) Filed: Jul. 18, 2014

Related U.S. Application Data
(60) Provisional application No. 61/856,298, filed on Jul. 19, 2013.

(51) Int. Cl. G06F 17/30

(52) U.S. Cl. CPC G06F 17/30946
USPC 707/782

(57) ABSTRACT

Systems and methods for facilitating access to open public records are provided. The system for facilitating access to open public records comprising an open public records computer system for electronically receiving a request for a public record from a requestor computer system of a requestor, and a database in electronic communication with the open public records computer system, the database storing an updatable index of custodians of records thereon, wherein the open public records computer system automatically identifies a custodian appropriate for the request from the index, and transmits the request anonymously on behalf of the requestor to a custodian computer system of the custodian identified thereby preserving an identity of the requestor.

### CROSS-REFERENCE TO RELATED APPLICATIONS

This application claims the benefit of U.S. Provisional Application Ser. No. 61/856,298 filed on Jul. 19, 2013, the entire disclosure of which is expressly incorporated herein by reference.

### BACKGROUND

1. Field of the Disclosure

The present disclosure relates to a system and method for facilitating access to open public records.

2. Background

Citizens and residents are allowed the potential for unprecedented access to government records throughout various levels of government (e.g., municipal, state, federal, etc.), usually as a result of legislation (e.g., New Jersey Open Public Records Act (OPRA)). However, the current system for filing a public records request (e.g., OPRA request) lacks standardization, accountability, and transparency. Individual municipalities handle requests differently, resulting in a filing process that can be confusing, difficult, and often inaccessible to citizens and residents. Requests are often wrongfully denied, costs for filing a request vary greatly across municipalities, and many people are reluctant to make requests for fear of retribution from government officials. Further, the current system lacks a centralized database to make the responses to requests available to the public. Therefore, there is a need for a system and method for facilitating access to open public records that addresses these challenges.

### SUMMARY

A system and method for facilitating access to open records is disclosed. The system allows for anonymous requests for public records from any number or types of government entities and provides a centralized location for custodians of records to handle such requests. Interactive tools are provided to requestors to assist them in creating a proper public records request. Interactive tools are also provided to custodians of records to fulfill requests and supply reasons and explanations for their decisions. An index of custodians of records for all levels of government can be created and updated by the system. Received requested documents can be archived and made publicly accessible. Any problematic requests can be flagged for community review and input for subsequent resubmission.

### BRIEF DESCRIPTION OF THE DRAWINGS

The foregoing features of the disclosure will be apparent from the following Detailed Description, taken in connection with the accompanying drawings, in which:

FIG. 1 is a diagram showing a system for facilitating open public records requests;

FIG. 2 is a diagram showing hardware and software components of a computer system on which the system of the present disclosure could be implemented;

FIG. 3 illustrates processing steps of the system of the present disclosure; and

FIG. 4 illustrates processing steps of the open public records system of the present disclosure.

### DETAILED DESCRIPTION

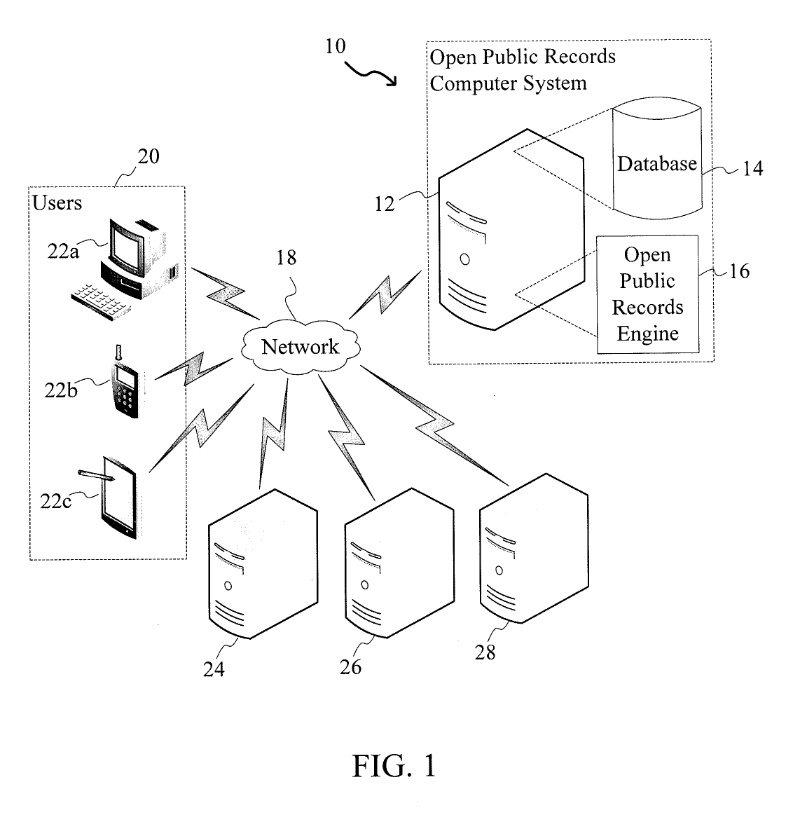

The present disclosure relates to a system and method for facilitating access to open public records, as discussed in detail below in connection with FIGS. 1-4. The open public records system (e.g., website, open source web application, smartphone app, tablet app, etc.) and method of the present disclosure promotes greater access to public records (e.g., municipal, state, and federal public records, etc.), streamlines the filing process for those seeking public records, and efficiently handles multiple requests. The open public records system encourages residents to learn more about the issues in their communities, share their findings with the public, and play a greater role in the state's civic and political life. It provides a platform for governmental transparency in every community and encourages community-driven discussion to take place around primary source documents. The system could be utilized by a variety of users (e.g., researchers, journalists, activists, attorneys, citizens, etc.) and improves the capacity for media outlets (e.g., television, print, web) to provide better reporting and coverage of municipalities, counties, state agencies, etc.

The open public records system (by default) can make requests anonymously on behalf of a requestor, thereby removing any chilling effect that may have existed from a fear of retribution from a government official. Requests (and related documents) can be fulfilled through the present system and made available to the public through an easily accessible centralized location (e.g., wiki-style archive). This alleviates the work of government entities that have to respond to redundant public disclosure requests because they can simply redirect such requests to the open public records system if such documents have already been provided. Further, the system fosters community support for understanding, collaboration, identifying wrongfully denied requests, and potential financial backing, as will be described. More specifically, as there are often filing fees and other administrative costs associated with a public records request, a requestor can use the system to seek a financial sponsor for the request (e.g., contacting members directly, posting in a forum, etc.).

An interactive tool is provided to requestors to assist them in creating a proper open public records request. The interactive tool could provide a simplified version of the public records request form with step by step instructions, prompt the requestor for all required information and then automatically format the request, and/or manage multipart requests piece by piece to ensure that all parts are fulfilled, etc. The open public records system could utilize a database to store and update a moderated index of custodians of records for all levels of government. Custodians of records are provided with interactive tools to fulfill requests and provide reasons and explanations for their decisions (e.g., explanation for denials). Additionally, custodians can manage all requests through a single system and interface.

FIG. 1 is a diagram showing a system for facilitating open public records requests, indicated generally at 10. The system 10 comprises a computer system 12 (e.g., a server) having a database 14 stored therein and an open public records engine 16. The computer system 12 could be any suitable computer server (e.g., a server with an INTEL microprocessor, multiple processors, multiple processing cores) running any suitable operating system (e.g., Windows by Microsoft, Linux, etc.). The database 14 could be stored on the computer system 12, or located externally (e.g., in a separate database server in communication with the system 10).

The system 10 is web-based and remotely accessible such that the system 10 communicates through a network 18 with one or more users over a variety of computer systems 20 (e.g., personal computer system 22a, a smart cellular telephone 22b, a tablet computer 22c, or other devices). Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. Further, the system 10 could communicate with a requestor system 24, a moderator system 26, and a custodian system 28, as explained in more detail below, such as through an application programming interface (API).

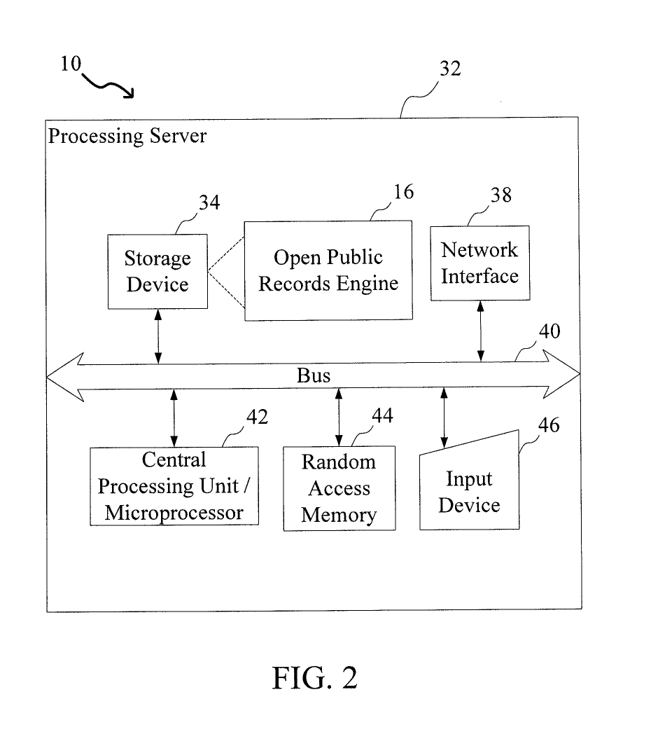

FIG. 2 is a diagram showing in more detail hardware and software components of a computer system 10 on which the system of the present disclosure could be implemented. The system 10 comprises a processing server 32 which could include a storage device 34, a network interface 38, a communications bus 40, a central processing unit (CPU) (microprocessor) 42, a random access memory (RAM) 44, and one or more input devices 46, such as a keyboard, mouse, etc. The server 32 could also include a display (e.g., liquid crystal display (LCD), cathode ray tube (CRT), etc.). The storage device 34 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 32 could be a networked computer system, a personal computer, a smart phone, tablet computer etc. It is noted that the server 32 need not be a networked server, and indeed, could be a stand-alone computer system.

The functionality provided by the present disclosure could be provided by an open public records program/engine 16, which could be embodied as computer-readable program code stored on the storage device 34 and executed by the CPU 42 using any suitable, high or low level computing language, such as Python, PHP, Java, C, C++, C#, .NET, MATLAB, etc. The network interface 38 could include an Ethernet network interface device, a wireless network interface device, or any other suitable device which permits the server 32 to communicate via the network. The CPU 42 could include any suitable single- or multiple-core microprocessor of any suitable architecture that is capable of implementing and running the engine 16 (e.g., Intel processor). The random access memory 44 could include any suitable, high-speed, random access memory typical of most modern computers, such as dynamic RAM (DRAM), etc.

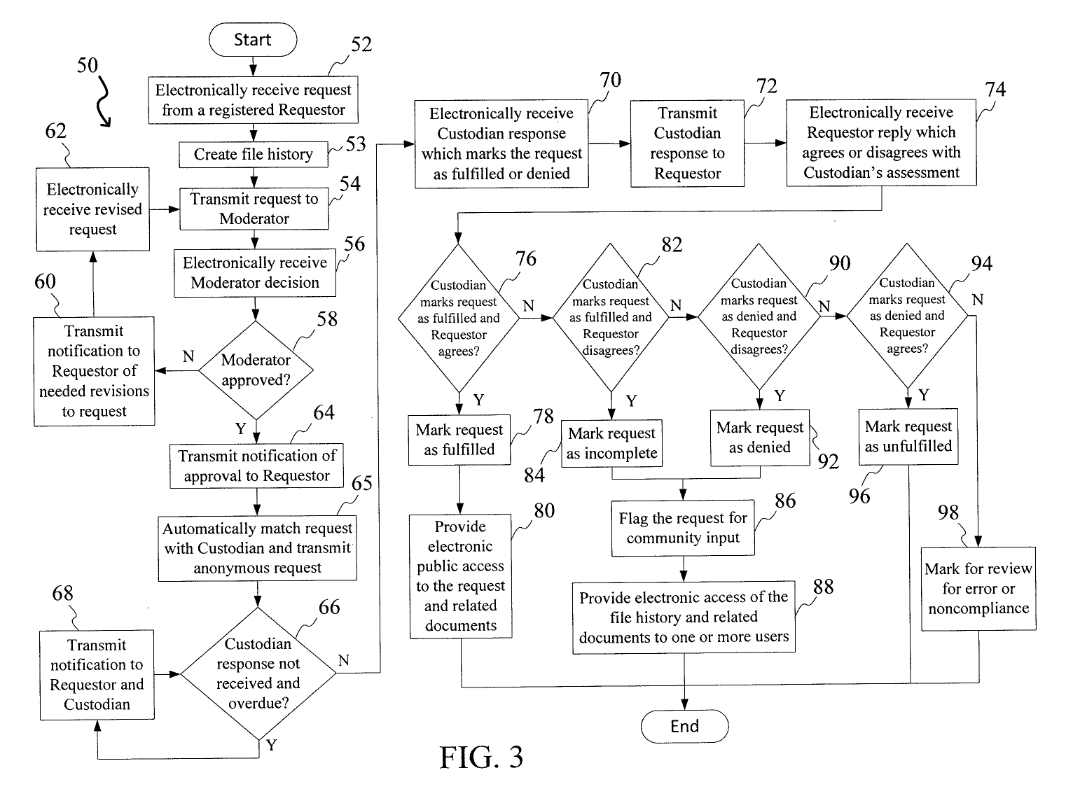

FIG. 3 illustrates processing steps 50 of the open public records system of the present disclosure. Of note, at least some of the functionality that is automatically provided by the system as described below could alternatively be provided manually by the requestor and/or an authorized user. In step 52, the open public records system electronically receives a request for public records from a requestor system 24 (see FIG. 1) of a requester registered with the system. A requestor (or any other user) can register with the open public records system by providing, for example, a username, password, identifying information (e.g., name, address, etc.), and contact information (e.g., email address, mailing address, etc.). To submit a request, the user may login to the open public records system using the username and password previously provided.

In step 53, the open public records system creates a file history and adds the initial request submission thereto. The file history can be reviewed by others as explained in more detail below. In step 54, the open public records system transmits for review the request to a moderator system 26, such as by email, posting, etc., (see FIG. 1) of a moderator registered with the system. The moderator can be a user authorized by the system to review requests for compliance and potential errors. This filters out improper requests early and decreases costs to the requestor. However, if a requestor has sufficient experience, as automatically determined by the open public records system (e.g., after a user has submitted five requests) or manually entered by an authorized user of the open public records system (e.g., administrator), the requestor can be its own moderator such that once the request is submitted to the open public records system it is then transmitted to a custodian system (as explained below) without first requiring moderator approval. Prior to moderator review, the requestor could edit the request as desired, and any edits could be recorded in the file history. In step 56, the open public records system electronically receives (e.g., email, account posting, etc.) the moderator's decision from the moderator system 26 (which could be recorded in the file history). In step 58, a determination is made as to whether the moderator approved the request. If a negative determination is made, in step 60 the open public records system transmits a notification to the requestor system 24 notifying the requestor of the denial and the revisions needed to the request. In step 62, the open public records system then subsequently receives a revised request from the requestor (which is recorded in the file history), and the process reverts to step 54. If a positive determination is made in step 58, then in step 64 a notification is transmitted to the requestor notifying him or her of approval by the moderator of the request.

In step 65, the open public records system automatically matches the request with a custodian of records from an index. The system compiles the index of custodians of records of all levels of government (e.g., municipal, county, state, federal, etc.) and determines which custodian is appropriate for the particular public record request being made based on the nature of the request (e.g., based on the level of government, department, geographic location, etc.). The index could be compiled in any number of ways including automatic Internet searches, crawling specific websites or databases, crowdsourcing, and/or manual user input (subject to moderation by site administrators).

Once the appropriate custodian is identified, the open public records system transmits (e.g., emails, posts to their account, etc.) the request to the custodian at a custodian system 28 (see FIG. 1) so that the identity of the original requestor is not revealed. In this way, a requestor registered with the system can make an anonymous request for public records without fear of retribution by government officials because the system acts as an intermediary between the requestor and the custodian of records such that only the system knows the identify of the requestor. The custodian can, but does not have to, be registered with the open public records system. After the request is transmitted to the custodian at the custodian system 28, the request can no longer be edited or revised by the requestor. Further, transmission of the request to the custodian starts the time period for review (which may be of a particular limit set by law), as discussed below. The open public records system could further include a payment system (e.g., PayPal integration, credit card processing, etc.) to facilitate payment of costs (e.g., filing fees, administrative fees, etc.) associated with the submission of the request. Alternatively, the request could be sent by physical mail and the system could facilitate payment of shipping costs, filing fees, and other costs.

In step 66, the open public records system determines whether the custodian's response is overdue based on a predetermined time period that starts running once the request is transmitted to the custodian. This predetermined time period could be a default setting, automatically set as the time period required by the request itself (if available), or set by the requestor or authorized user. If the custodian response is overdue, the process proceeds to step 68 and the open public records system transmits a notification to the requestor and custodian notifying them that a response is overdue (and adds this event to the file history). Overdue requests could also be highlighted for community review and input. The process then reverts back to step 66, so that these reminder notifications reoccur until the custodian's response is received (i.e., notifications are sent every week, two weeks, month, two months, etc.). If in step 66 the system determines the response is not overdue and has been received, the process proceeds to step 70.

In step 70, the open public records system receives the custodian response (e.g., by email, uploaded directly to the system, scanned into the system (if physically mailed), etc.) which marks the request as fulfilled or denied (and is added to the file history). The custodian response could include text comments as well as attached files (if the response is emailed) or uploaded files (if the response is uploaded directly to the system). In this way, the custodian could answer questions regarding the response, supply the requested document(s), or deny the request with an explanation and appropriate documentation. In step 72, the system transmits the custodian's response to the requestor (thereby preserving the anonymity of the requestor). In step 74, the system receives the requestor's reply (e.g., by email, a reply uploaded directly to the system, etc.) to the custodian's response (which is then added to the file history).

In step 76, the open public records system evaluates the content of the custodian's response and the requestor's reply and determines whether the custodian marked the request as fulfilled and the requestor agreed. If a positive determination is made, then in step 78 the system marks the request as fulfilled and in step 80 (unless otherwise indicated by the custodian or the requestor) provides electronic public access to the request and related documents (which is added to the file history). As a result, if a custodian receives future requests for the same document, the custodian can direct the future requests for the same information to the open public records system. Further, fulfilled requests can be shared via social media websites, tagged by users of the open public records system, and/or discussed through comments.

If a negative determination is made in step 76, then in step 82 the open public records system determines whether the custodian marked the request as fulfilled and the requestor disagreed. If a positive determination is made, then in step 84 the system marks the request as incomplete (which is added to the file history) which usually indicates that the requestor believes the custodian's response was not responsive to the request. In step 86, the system flags the request (e.g., “Status: Troubled Request”) for community review and input and in step 88 provides electronic access to the file history and related documents (e.g., private user to user messages, public website posting, publicly accessible website archive, etc.) to one or more users (e.g., user(s) selected by the requestor, or the public, etc.). In this way, the community can evaluate the problematic request and file history and weigh in on whether they agree with the custodian's response and/or offer suggestions for improving the request or otherwise resolving any issues. Depending on the community feedback, the requestor could then revise and/or resubmit the request, which would restart the above process.

If a negative determination is made in step 82, then in step 90 the open public records system determines whether the custodian marked the request as denied and the requestor disagreed. If a positive determination is made, then in step 92, the request is marked as denied (which is added to the file history), and the process proceeds to step 86, discussed above. Preferably, a custodian will indicate the cause or reason for denial and offer ways to improve the request. Regardless, the community can then offer their input to improve and revise the request, and the requestor could then revise and/or resubmit the request.

If a negative determination is made in step 90, then the process proceeds to step 94 and the open public records system determines whether the custodian marked the request as denied and the requestor agreed. If a positive determination is made in step 94, then in step 96 the request is marked as unfulfilled (which is added to the file history). If a negative determination is made in step 94, and none of these scenarios are applicable (e.g., due to a system timeout from the requestor failing to submit a reply, due to a technical error in the system itself, or any other reason), then in step 98 the system marks the request as requiring review for error or noncompliance in the request, the custodian response, and/or the requestor reply.

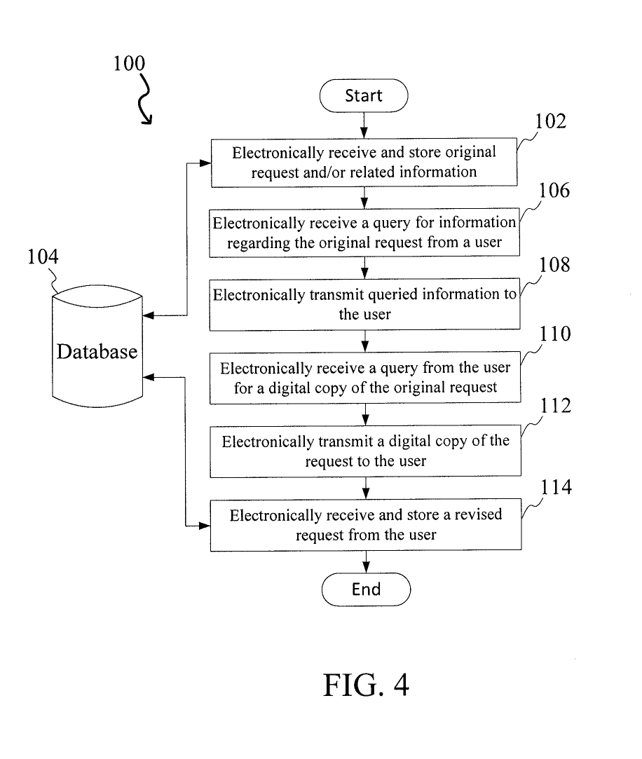

FIG. 4 illustrates processing steps 100 of the open public records system of the present disclosure. The system (e.g., the open public records system) facilitates user access to previously filed requests (e.g., from a central database), which allows users to make duplicate versions of the request to reuse and/or modify the request as needed. In this way, the system could guide a requestor through making an initial request (e.g., regarding form of the request, incorporating boilerplate language, etc.), and then utilize community input for the more specific or unique aspects of their request.

In step 102, the system electronically receives and stores (e.g., in a database 104) an original request and/or related information (e.g., regarding the outcome of the request) from a requestor. The system can monitor/track (and requestors can report) the success and/or failure of an open public records request in obtaining the documents sought by the requestor. For example, a requestor can indicate the outcome (e.g., fulfilled, incomplete, denied, unfulfilled, etc.) of an open public records request through a survey requested by the system after the open public records request process is completed.

In step 106, the system electronically receives a query from a user for information regarding the original request (or a type of request, or any other particular request, etc.). In step 108, the system electronically transmits the queried information to the user. This allows a user to compare preliminary information regarding a request (e.g., success rate, user ratings, etc.). In step 110, the system electronically receives a query from the user for a digital copy of the original request (and/or any other particular request). The original request could be visible on the user's public profile and/or could be searchable in the central database. In step 112, the system electronically transmits a digital copy of the original request (and/or any other particular request) to the user. This allows users to search for (and/or view) a particular type of request and choose from the most successful and/or popular request among them. One or more users can download a digital copy of a particular request to improve the request and/or to tailor the request to the user's particular needs and situation.

In step 114, the system electronically receives and stores (e.g., in a database 104) a revised request from the user. The revised request could be received as a result from the user filing his/her own request, and/or to improve the original request. The system thereby makes the revised request searchable and accessible to users for further copying and/or revisions. This also allows the requestor to incorporate the changes into his/her own original request.

Optionally, when a request is duplicated and/or modified, the original requestor (and/or the creator of that particular version) could be notified (e.g., by a counter) that his/her request was duplicated and/or modified by another user.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A system for facilitating access to open public records, comprising:
an open public records computer system for electronically receiving a request for a public record from a requestor computer system of a requestor; and
a database in electronic communication with the open public records computer system, the database storing an updatable index of custodians of records thereon,
wherein the open public records computer system automatically identifies a custodian appropriate for the request from the index, and transmits the request anonymously on behalf of the requestor to a custodian computer system of the custodian identified thereby preserving an identity of the requestor.

2. The system of claim 1, wherein the open records computer system receives a custodian response, transmits the custodian response to the requestor, receives a requestor reply, and determines whether the custodian response and requestor reply are in agreement.

3. The system of claim 1, wherein the open public records computer system transmits the request to a moderator system of a moderator for review for compliance and potential errors.

4. The system of claim 1, wherein the open public records computer system automatically determines whether the requestor requires moderator approval.

5. The system of claim 1, wherein the open public records computer system determines whether a custodian response is overdue based on a predetermined time period, and if overdue transmits a notification to the requestor.

6. A method for facilitating access to open public records, comprising the steps of:
electronically receiving at an open public records computer system a request for a public record from a requestor computer system of a requestor;
automatically identifying, by the open public records computer system, a custodian appropriate for the request from an updatable index of custodians of records stored in a database; and
transmitting, by the open records computer system, the request anonymously on behalf of the requestor to a custodian computer system of the custodian identified thereby preserving an identity of the requestor.

7. The method of claim 6, further comprising:
receiving, at the open records computer system, a custodian response;
transmitting, by the open records computer system, the custodian response to the requestor.
receiving, at the open records computer system, a requestor reply; and
determining whether the custodian response and requestor reply are in agreement.

8. The method of claim 6, further comprising transmitting, by the open public records computer system, the request to a moderator system of a moderator for review for compliance and potential errors.

9. The method of claim 6, further comprising automatically determining, by the open public records computer system, whether the requestor requires moderator approval.

10. The method of claim 6, further comprising determining, by the open public records computer system, whether a custodian response is overdue based on a predetermined time period, and if overdue transmitting a notification to the requestor.

11. A non-transitory computer-readable medium having computer-readable instructions stored thereon which, when executed by an open public records computer system, cause the computer system to perform the steps of:
electronically receiving at the open public records computer system a request for a public record from a requestor computer system of a requestor;
automatically identifying, by the open public records computer system, a custodian appropriate for the request from an updatable index of custodians of records stored in a database; and
transmitting, by the open records computer system, the request anonymously on behalf of the requestor to a custodian computer system of the custodian identified thereby preserving an identity of the requestor.

12. The computer-readable medium of claim 11, further comprising:
receiving, at the open records computer system, a custodian response;
transmitting, by the open records computer system, the custodian response to the requestor.
receiving, at the open records computer system, a requestor reply; and
determining whether the custodian response and requestor reply are in agreement.

13. The computer-readable medium of claim 11, further comprising transmitting, by the open public records computer system, the request to a moderator system of a moderator for review for compliance and potential errors.

14. The computer-readable medium of claim 11, further comprising automatically determining, by the open public records computer system, whether the requestor requires moderator approval.

15. The computer-readable medium of claim 11, further comprising determining, by the open public records computer system, whether a custodian response is overdue based on a predetermined time period, and if overdue transmitting a notification to the requestor.
